(19) United States
(12) Patent Application Publication
(10) Pub. No.: US 2009/0157472 A1
(43) Pub. Date: Jun. 18, 2009

(54) Personalized Retail Information Delivery Systems and Methods

(75) Inventors: Mark A. Burazin, Oshkosh, WI (US); Thomas Gerard Shannon, Neenah, WI (US); Henry L. Griesbach, III, Atlanta, GA (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC., Neenah, WI (US)

(21) Appl. No.: 11/956,999

(22) Filed: Dec. 14, 2007

(51) Int. Cl. G06F 17/00; G06Q 30/00

(52) U.S. Cl. 705/10

(57) ABSTRACT

A personalized shopping system can provide for delivery of relevant information that is responsive to the needs and desires of shoppers. Any suitable information can be delivered including, but not limited to, advertisements. By taking one or more preferences or parameters of the shopper into account, the advantages of targeted advertising and/or other information delivery can be achieved with reduced adverse effects on shoppers. To the contrary, the shoppers may benefit from the system, since it is configured to address the needs of the shopper, rather than the needs of only the manufacturer, retailer, advertiser, or other information purveyor. The system can evaluate whether to present information at various opportunities based on the shopper's media preferences. Further, the system may respond to user requests for information. The system may be configured to provide navigational guidance, such as a map through a retail location, for use by a shopper.

### BACKGROUND

Currently-existing systems and methods for enhancing the experience of shoppers at retail locations suffer from several deficiencies. For instance, point-of-sale advertisements are generally not “targeted.” Rather, the advertisements are presented to any shoppers that happen to be in the vicinity of the ad. Proposals have been made for more advanced “targeted” advertisements through the use of directional audio systems based on ultrasonic principles. However, even such closely-targeted audio may be heard by adjacent shoppers in some circumstances. Furthermore, these and other targeted in-store advertisements may result in an unpleasant experience for some shoppers, who may feel “pinned down” and otherwise annoyed by a constant barrage of potentially-irrelevant information.

### SUMMARY

In accordance with one or more aspects of the present subject matter, a personalized shopping system can provide for delivery of relevant information that is responsive to the needs and desires of shoppers. Any suitable information can be delivered including, but not limited to, advertisements. By taking one or more preferences or parameters of the shopper into account, the advantages of targeted advertising and/or other information delivery can be achieved with reduced adverse effects on shoppers. To the contrary, the shoppers may benefit from the system, since it is configured to address the needs of the shopper, rather than the needs of only the manufacturer, retailer, advertiser, or other information purveyor.

In some embodiments, a system for providing a personalized shopping experience can comprise at least one media presentation device and at least one computing device. As will be discussed below, any suitable number, type, and configuration of media presentation devices and computing devices can be used to implement embodiments of the present subject matter.

The computing device(s) may be configured to determine when a shopper has arrived at a retail location and identify the shopper. This may be done in any number of ways, including by tracking RFID signals emanated by one or more objects associated with the shopper (or the shopper him or herself), tracking one or more computing devices such as a phone, personal digital assistant, or computer carried by the shopper, or by identifying one or more other characteristics of the shopper (e.g. facial recognition, iris scanning, voice recognition, etc.) or objects associated with the shopper (e.g. scanning a bar code on a shopper card).

Identifying when a shopper has arrived at a retail location can comprise tracking the shopper's location at any suitable level of detail. For instance, in some embodiments, the shopper can be tracked beginning from when the shopper enters a store or other establishment until the shopper exits. While at the store or other establishment, the shopper's absolute or relative location may be tracked. For instance, the shopper's location relative to products, displays, other shoppers, and/or areas of the store may be tracked or determined.

The computing device(s) can be configured to access data indicating at least one media preference of the shopper with regard to in-store media. Media preference data can comprise any suitable data that indicates the shopper's desired experience with regard to media presented to the shopper while at one or more particular retail locations. The data may provide for general preferences and/or specific preferences. For instance, media preference data may indicate a shopper's willingness to view advertisements of one or more types at any point in a store. As another example, media preference data may indicate a shopper's desired background media, such as preferred music or other audio to be provided while shopping. Still further, media preference data may indicate one or more types of information desired by the shopper at particular times. For instance, the shopper may desire information about a particular product, a particular type of product, or may want information about suitable products to meet one or more needs identified in the media preference parameter data. For example, the media preference data may indicate that the shopper wants information about items on a shopping list, which can be referenced by or included in the media preference data.

While the shopper is at a retail location, the computing device(s) can identify at least one media presentation opportunity at which media can be presented to the shopper. For instance, a media presentation opportunity may comprise a suitable point at which a targeted advertisement may be provided to the shopper. As another example, a media presentation opportunity may comprise a point at which background music, requested information, or an incentive may be provided to the shopper. One or more media presentation opportunities may be location-based, such as based on proximity to one or more products or areas of a store, although other media presentation opportunities may be more general.

The computing device(s) can be configured to determine, for each media presentation opportunity, whether the shopper desires to receive the media presentation associated with the opportunity. Further, the computing device(s) can be configured to send one or more signals to one or more media presentation devices to present a media presentation to the shopper in accordance with the shopper's media preferences

For example, if a shopper is near a display for a certain product and the shopper's media preference data indicates a willingness to receive advertisements or information about the product, then the advertisement or information can be provided to the shopper. For example, the computing device(s) may send appropriate signals to an audio speaker near the display to provide an audio advertisement or message.

However, if the shopper's preference data indicates that no advertisements are desired, then an advertisement is not provided. Thus, the shopper can “opt out” of some or all targeted advertisements.

In some embodiments, the computing device(s) are further configured to receive data identifying a change in the shopper's media preference data while the shopper is at the retail location. A “change” can include an alteration to existing data, removal of some or all of the data, and/or addition of new data. Thus, the shopper who earlier “opted out” of certain presentations can “opt in” while at the location and a shopper who “opted in” can “opt out” while at the location. For example, when a shopper is near a particular display, the shopper may change his or her mind and wish to receive (or stop receiving) information or advertisements about the product. As another example, a shopper who wishes to receive a coupon or other incentive can opt-in to receive one or more advertisements in exchange for the incentive.

Data indicating one or more changes in the media preference data can be received in any suitable way. For instance, in some embodiments, the system comprises one or more input devices, such as a microphone (or set of microphones) in communication with the computing device(s). The data identifying the change can be derived from an audio request made by the shopper via the microphone(s), such as by voice recognition. As another example, the computing device(s) can be configured to receive data indicating the change(s) from one or more other computing devices that are associated with the shopper. For instance, the shopper may use his or her phone, PDA, or other device(s) to change one or more parameters in the media preference data.

As was noted above, in some embodiments, a change in media preference data can comprise a request for information from the shopper. The system computing device(s) can be configured to select a set of data based on the request and provide the selected data to the shopper. For instance, the set of data can comprise a media presentation provided to the shopper via one or more media presentation devices at the location. For instance, the media presentation may be an audio, visual, audiovisual, or other advertisement. As another example, providing the set of data can comprise sending the data to one or more computing devices associated with the shopper. The set of data can comprise an advertisement presented using the shopper's computing devices, or may comprise information not presented as an advertisement.

In some embodiments, the system can comprise one or more noise-cancellation devices at the retail location. As an example, a noise-cancellation device can comprise one or more directional audio systems configured to send sound waves which cancel out other sound waves a particular location. When multiple shoppers are at a location, a second shopper may not wish to hear advertisements presented to another shopper at the location. This may be reflected in the second shopper's media preference data. The system computing device can be configured to send one or more signals to the noise cancellation device(s) so that, when a media presentation is provided to the other shopper, audio from the presentation is substantially cancelled out from the point-of-view of the second shopper.

In some embodiments, the computing device(s) can be configured to offer one or more incentives to a shopper in exchange for the shopper selecting one or more particular preference regarding in-store media. For instance, the particular preference(s) may indicate a willingness to receive one or more advertisements. Accordingly, a shopper can bargain for incentives, such as coupons, discounts, or other expressions of value in exchange for viewing, listening to, or otherwise being provided a media presentation.

In some embodiments, identifying a media presentation opportunity can be based in part on data indicating prior or impending purchases by the shopper. For example, purchase history data, such as from a loyalty or tracking program, may be used. Impending purchases may be inferred from the presence of items in proximity to a shopper while at a retail location and/or from shopping lists or other information.

As was noted above, in some embodiments, a media presentation can comprise an audio message. However, a media presentation can comprise video only, audio only, audiovisual media, still visual media, and the like. Media presentation devices can comprise audio systems, directional audio systems, video systems, screens, posters, and other visual display devices, and/or printers of any type. For example, in some embodiments, a media presentation comprises printed material such as a coupon. In some embodiments, a media presentation is provided by one or more computing devices associated with a shopper, such as a cellular telephone (cell phone), personal digital assistant (PDA), music player, convergence device (e.g. phone/pda/music player), or other computing device or devices. In such embodiments, a media presentation device can comprise one or more devices used to establish a network link with the shopper device(s) and send data to the shopper device(s).

In some embodiments, identifying at least one media presentation opportunity comprises identifying an opportunity to provide information regarding a pharmaceutical product. For example, a retail location may comprise a pharmacy, pharmacy section, and/or may sell prescription, over-the-counter, and other drugs (including, for instance, herbal remedies and nutritional supplements). In such instances, at least one media presentation comprises information about drug interactions or contraindications. Identifying a media presentation opportunity can be based at least in part on accessing data indicating at least one previous or impending purchase of the shopper and accessing data regarding drug interactions or contraindications with regard to at least one previous or impending purchase of the shopper. In some embodiments, it may be particularly advantageous for the media presentation to be provided by interfacing with a computing device associated with the shopper and send data comprising the media presentation to the computing device associated with the shopper. In order to comply with applicable laws and regulations, the at least one computing device can be further configured to receive data confirming that the shopper has received the media presentation and/or the particular pharmaceutical product(s).

In some embodiments the at least one computing device of the personalized shopping system is further configured to provide an interface whereby a shopper can specify at least one media preference. For example, in some embodiments, the interface comprises a web site. In some embodiments, the personalized shopping system is configured to interface with a computing device associated with the shopper and derive at least some media preference data from data stored on the computing device associated with the shopper. For example, the shopper can define rules or generalized desires which are interpreted by the personalized shopping system to establish particular rules used in identifying and responding to media presentation opportunities.

In some embodiments, the computer system comprising a personalized shopping system can be configured to determine when a shopper has reached a retail location and identify the shopper and evaluate shopper preference data indicating whether the shopper desires for a personalized shopping system to respond in an active or passive form. While the shopper preference data indicates the shopper desires for the personalized shopping system to respond in a passive form, the system can be configured so as to provide at least one media presentation to the shopper only in response to an inquiry provided by the shopper. For example, the system may identify one or more media presentation opportunities only after a request has been made, or the system may identify opportunities, but only act on such opportunities to present information pertaining to a request.

In some embodiments, while the shopper preference data indicates the shopper desires for the personalized shopping system to respond in an active form, the system is configured to provide at least one personalized media presentation to the shopper in accordance with media preference data from the shopper. For instance, targeted advertisements based on in-store proximity, shopping lists, demographic information, and/or in-store activity may be provided without waiting for an explicit request from the shopper. Of course, the system may continue to be responsive to shopper requests for specific information, as well.

In some embodiments, a personalized shopping system computer can be configured to access data identifying one or more items desired by a shopper and determine the position of at least one identified item at one or more retail locations. Based on the position(s), the system can determine a route through one or more retail locations so that a shopper following the route will be in proximity to the identified positions. Based on the determined route, the system can provide one or more media presentations comprising navigational guidance to a shopper. For instance, the presentations can comprise a map of the retail location and one or more determined routes. The maps may be presented by sending data comprising the map to a printer at a retail location and/or sending data comprising the map to a computing device associated with the shopper.

In some embodiments, the system can access data indicating the shopper's position within a retail location and determine a direction for the shopper to move based on a determined route. Providing a media presentation comprising navigational guidance can include sending data to at least one speaker at the retail location, the data comprising an audio message to a shopper indicating the direction for the shopper to move. Of course, visual or other media presentations can be used to direct shoppers in store, as well.

In some embodiments, the system is further configured to determine an inventory status of at least one identified item at a plurality of retail locations and select a retail location for visitation by the shopper based on the determined inventory status. For example, a shopper may be sent to a particular location with the desired items in-stock.

### BRIEF DESCRIPTION OF THE DRAWINGS

FIG. 1 is a diagram illustrating components and the context of an exemplary personalized shopping system at a retail location;

FIG. 2 is a flowchart showing steps in an exemplary process for providing a personalized shopping experience;

FIG. 3 is a flowchart showing steps in an exemplary sub-process for a personalized shopping system which provides one or more incentives in exchange for presenting media to a shopper;

FIG. 4 is a block diagram showing one exemplary embodiment of a personalized shopping system in the context of other systems and devices;

FIG. 5 is a flowchart showing steps in another exemplary process for providing a personalized shopping experience;

FIG. 6 is a flowchart showing steps in an exemplary embodiment of providing a personalized shopping experience where a media presentation comprises in-store navigational guidance; and

FIG. 7 is an exemplary media presentation comprising navigational guidance for a shopper as presented in the form of a map through a retail location.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

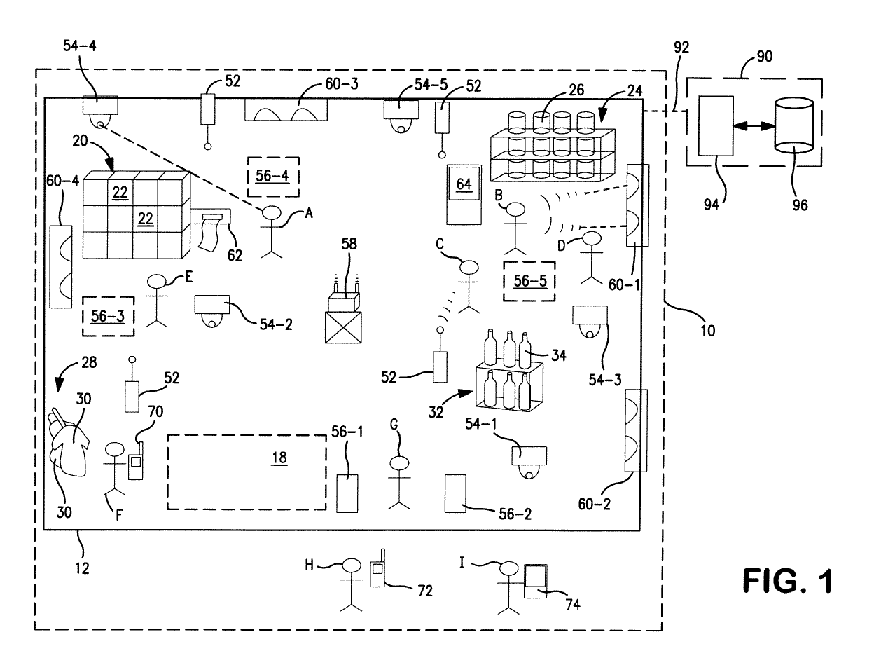

FIG. 1 illustrates an exemplary retail environment which may benefit from one or more embodiments of the present subject matter. In this example, a retail location 10 comprises the interior and exterior of a store 12, which may sell any number or type of goods and/or provide services to various customers. In this example, store 12 comprises entrance area 16 and checkout area 18, which are not shown in detail. Exemplary customers or shoppers A, B, C, D, E, F, G, H, and I are shown at various points at retail location 10, with customers H and I just outside the store.

The use of the term “customer” and “shopper” is meant to be synonymous, with the understanding that, in some instances, a person may enter a store, obtain information, and leave the retail location without paying for any products or services. Further, a customer/shopper can comprise any individual, regardless of age, sex, nationality, and the like.

In this example, store 12 comprises display 20 of product 22, display 24 of product 26, display 28 of product 30, and display 32 of product 34. The products are for purposes of illustration only. For instance, display 20 may comprise several different boxed personal care products 22, which may be of the same or different configurations, and may represent items provided by several different manufacturers. Display 24 of products 26 may represent canned or other packaged food items, while display 32 of products 34 may represent bottled food items. Display 28 may represent several different types and styles of clothing 30. However, other types of products may be used in conjunction with the present subject matter, and particular examples of products given herein are not intended to be limiting.

Store 12 includes several different media presentation devices which are capable of providing media to shoppers at retail location 10. In this example, media presentation devices include speakers 60, printer 62, and video display 64.

Speakers 60 may represent any type or types of audio presentation systems. For instance, in some embodiments, speakers 60 comprise a directional audio system which can provide targeted audio to one or more persons without the audio reaching other persons. Speakers 60 may further be configured to provide noise-cancellation to some persons using similar principles. In other embodiments, speakers 60 may comprise standard audio speakers which provide audio throughout store 12, or at certain locations. For instance, one or more speakers 60 may be associated with a product display. Printer 62 can be used to provide any number, size, and configuration of printed materials, including, but not limited to, coupons, flyers, and the like. In this example, printer 62 is positioned near display 20 of products 22. Video display 64 is shown positioned near display 24 of products 26. For instance, display 64 in this example is part of a video kiosk. However, in other embodiments, video display 64 may comprise a monitor suspended from the ceiling of store 12, positioned on a display (such as display 24), or may represent video projected onto a suitable surface visible to customers in the store.

Store 12 includes several input devices which can be used to recognize customers and other persons in the store. In this example, several cameras 54 are positioned throughout the store. Cameras 54 may comprise any suitable number and type of devices which can obtain visual representations of store 12 and/or persons or other objects therein. For example, cameras 54 may comprise still or video cameras. As another example, cameras 54 may comprise retinal scanners or other devices which can recognize particular features of individual customers or other persons.

A plurality of microphones 52 are also positioned throughout store 12. In some embodiments, some or all microphones 52 comprise part of a directional audio system which can isolate/identify audio originating from a particular location or area. For instance, certain microphones 52 may be ‘focused’ to register sound from a particular area and/or sounds may be localized by analysis of audio received by multiple microphones throughout store 12.

A plurality of RFID scanners 56 are positioned throughout store 12, as well. For instance, RFID scanners 56 may be positioned at or near entrance 16 so as to recognize customers, such as customer G, by receiving one or more signals from RFID chips or tags associated with customers nearby. Additionally, in this example, scanners 56 are located near some of the product displays. RFID scanners 56 may recognize customers in any suitable manner, such as by directly or indirectly identifying the customer from one or more RFID tags or chips carried on or by the customer.

For instance, some customers may use cell phones, such as phones 72 and 76, or other computing devices 74 (e.g. PDA, laptop/tablet/other computer) which comprise an RFID tag or chip or otherwise provide a signal which can be recognized by scanners 56. Additionally or alternatively, one or more objects carried on or by the customer may comprise a suitable tag or chip. For instance, a customer may carry a credit, debit, or bank card comprising a tag or chip. As another example, a customer loyalty card may comprise an RFID tag or chip. RFID scanners 56 may be operative to identify one or more products carried by customers as they enter, exit, and/or move through store 12 and/or retail location 10, as well.

In this example, store 12 further includes one or more wireless data access points 58. An access point 58 may comprise any suitable device configured to provide a wireless network connection between computing devices. As an example, wireless data access points 58 may be configured to interact with computing devices using standards such as Bluetooth and/or Wi-Fi (including various communication standards under IEEE 802.11). As another example, wireless data access points 58 may comprise hardware which can be used to track and/or interface with cellular telephones of customers or other persons in the store. For example, a customer's cellular telephone can provide data, such as GPS data, which is used to track the customer's location and/or cellular signals could be triangulated. Other wireless communication and/or tracking techniques may be used, as well such as infrared (IR)-based communication. The retail location could include one or more areas where shoppers could interface their computing device(s) for a wired or other network connection, as well.

I/O devices such as 52, 54, 56, and 58, and media presentation devices such as 60, 62, and 64 are interfaced in this example via connection 92 to a computer system 90 which comprises at least one computing device 94. Computing device(s) 94 have access to one or more databases 96 comprising media preference data of customers, with the media preference data (when available) used to provide a personalized shopping experience that is in accordance with the preferences of the customers as discussed in further detail below. Devices at retail location 10 may be interfaced directly or indirectly to system 90. For instance, the media presentation systems and/or input systems may each themselves comprise one or more computers or controllers, with the respective computers or controllers interfaced to system 90.

Connection 92 represents any suitable type or number of connections between the computer/processing components of system 90 and the media presentation devices, I/O devices, and other equipment positioned at the retail location. In some embodiments, computer system 90 may be located at or near retail location 10, while in other embodiments, computer system 90 is located remote from retail location 10 and interacts with components at location 10 via a wide-area network connection. Of course, aspects of computer system 90 may be distributed to multiple locations, which may or may not include retail location 10.

Computer system 90 may represent a dedicated computer system for providing personalized shopping to customers at one or more retail locations 10. However, in other embodiments, computer system 90 can comprise another system providing additional functionality for one or more retail locations 10 (e.g. point-of-sale system support, accounting, inventory, etc.) which is further configured to support a personalized shopping experience in accordance with aspects of the present subject matter. For instance, a retailer may already maintain a loyalty program which tracks customer preferences and/or purchases. The personalized shopping system may interact with and/or access data maintained by the computing system(s) which support the loyalty program and/or the personalized shopping system may be implemented as a part of the system(s) which support the loyalty program. Thus, data store 96 is shown to represent one or more databases maintaining the underlying data used to provide the personalized shopping system. This data can include rules and parameters for evaluating shopper media preferences and the shopper media preference data for one or more shoppers. The database(s) can be maintained in any suitable physical or logical arrangement.

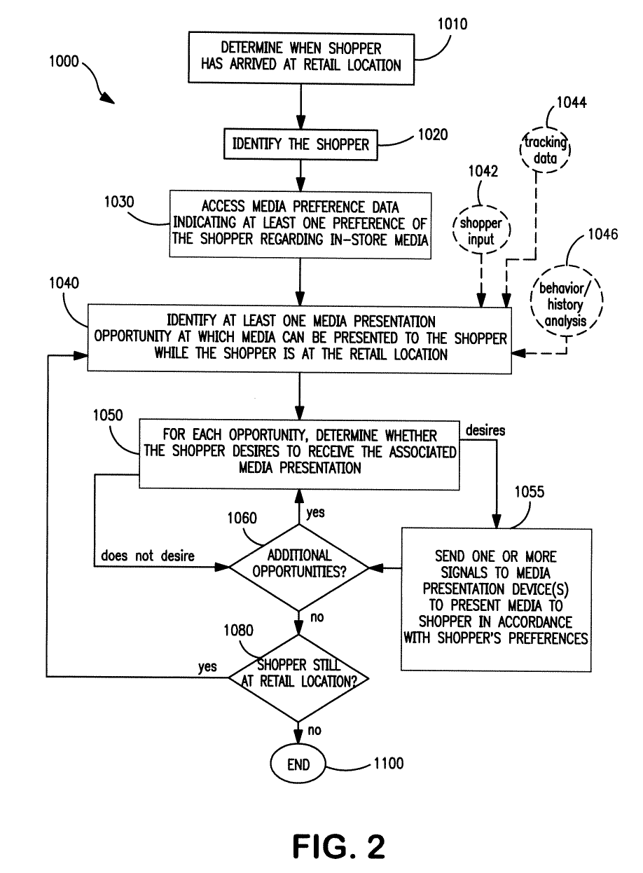

FIG. 2 is a flowchart showing steps in an exemplary process 1000 for providing a personalized shopping experience. It will be understood that the steps shown in process 1000 can be varied in any suitable manner to achieve the desired results, and process 1000 is for purposes of illustration and example only. For instance, in practice, various steps of process 1000 may be combined and/or broken down into sub-steps, and the steps may be carried out in a different order in some embodiments. Further, some steps may occur in parallel and/or several instances of the process (and/or portions thereof) may be carried out in parallel. Shoppers may be treated individually in some embodiments, while in other embodiments, shoppers are treated in groups.

At step 1010, the personalized shopping system determines when a shopper has arrived at a retail location, and at step 1020, the shopper is identified. This can be achieved in any number of ways. For example, a shopper may be recognized by computer analysis of visual and/or auditory data, including, but not limited to, biometric analysis such as facial recognition, retinal scanning, fingerprint scanning, and/or voice recognition/analysis. The shopper may be recognized by signals or analysis of one or more objects carried with, on, or by the shopper. For instance, a shopper may be recognized based on signals from one or more RFID chips or tags on the shopper's clothing, on items carried by the shopper (e.g. credit cards, key chains, cellular telephones), and/or embedded in the shopper. As another example, aspects of objects carried with, on, or by the shopper may be analyzed by the system, such as by scanning a bar code on a loyalty card or on one or more items of the shopper.

As yet another example, the shopper may “check in” at a kiosk or other suitable interface by swiping a card, scanning a bar code or other indicator, and/or by entering data (e.g. a PIN, account number, or even by directly entering the shopper's name and other pertinent information). Determining when the shopper has arrived at a retail location and identifying the shopper may occur simultaneously or at separate times, and the two steps may or may not use the same techniques.

The shopper can be identified by correlating suitable data to a profile or other information maintained regarding the shopper. The level of detail maintained regarding the shopper can be at any suitable level of particularity. For instance, in some embodiments, the personalized shopping system maintains, or has access to, purchase history, demographic data, and other information regarding the shopper. Some or all of the information may be provided by the shopper him or herself and/or the information can be provided by third parties or obtained through tracking the shopper's purchase history and in-store behaviors.

At step 1030, the personalized shopping system access media preference data indicating at least one preference of the shopper regarding in-store media. The media preference data can comprise any suitable set or sets of information that set forth the shopper's expectations and desires about media presented to the shopper as a result of the shopper's in-store activities. For example, the shopper may provide information which defines a set of rules that are used by the personalized shopping system to determine which types of media to provide to the shopper while he is at the retail location, and which types of media not to provide to the shopper. As another example, the shopper may provide other information, such as generalized desires regarding media and conditions for presentation, with specific rules determined by the personalized shopping system based on the shopper's generalized information.

The media preferences can be provided to the personalized shopping system in any suitable way. For example, the personalized shopping system may receive data from shoppers by way of a web site or other computer interface, such as a kiosk, that allows shoppers to log on and set forth their preferences. For example, a chain of stores may maintain a web site where shoppers can log in and provide media preferences and other parameters used to provide a personalized shopping experience.

As another example, the shopper may provide data to the system via voice, e-mail, or other communications from a cellular telephone or PDA while at the retail location and/or while at another location. For instance, a shopper may provide generalized instructions/preferences to a program on the shopper's PDA, cellular telephone, or other computing device(s). The computing device(s) can interface with the personalized shopping system in order for the personalized shopping system to identify the shopper's media presentation preferences. This may occur before a shopper arrives at a retail location and/or when the shopper arrives at the location.

The media preferences can pertain to advertisements, but also to other aspects of the shopping experience, such as the shopper's preferred background music, and the particular manner in which the shopper desires to have information provided to him or herself. For example, as will be noted below, shoppers may, in some embodiments, specify that any information is to be provided only in response to an inquiry from the shopper and, therefore, the personalized shopping system operates in a “passive response mode” as to that shopper.

Additionally, the shopper's preferences may indicate the degree to which the shopper wants to be “protected” from media presented to other shoppers at a retail location. For example, a shopper may wish to shop “in peace” without being subjected to advertisements and/or background music directed to other shoppers, and indicate this wish in his media preferences.

Further, the shopper may indicate which types of activities are to be used as a basis for providing media to the shopper, and which types of activities are off-limits. For example, in a grocery store, a shopper may have no problem with advertisements which are presented based on the shopper's proximity to a display, but may object to the use of data regarding other items selected by the shopper and placed in her cart. This may be a blanket restriction, or may extend only to certain products or classes of products. For instance, the shopper may declare targeted advertising based on the presence of feminine hygiene products in her cart to be off-limits; alternatively, the shopper may indicate that only certain types of advertisements, such as coupons, may be presented, while others (such as audio or video advertisements) are off-limits.

The media preference data may indicate the shopper's desires regarding media presented to the shopper, but not publicly displayed to the shopper, at the retail location. For example, the shopper may indicate a willingness to receive advertisements or information on one or more computing devices associated with the shopper, such as a cell phone, PDA, or home PC (e.g. a brochure emailed to the shopper).

The media preference data may also indicate information that is desired by the shopper. For instance, the shopper may provide an explicit list of desired items, such as a shopping list, drug prescription, bill of materials, etc. to the personalized shopping system and request information regarding one or more items. Advertisements and other media can be presented to the shopper at the retail location based on the requested information. In some embodiments, the request does not explicitly identify items for which the shopper desires information, but may identify classes of items or may comprise a request for information about one or more items complimentary to other items which are specified by the shopper. As will be noted in more detail in an example below, in some embodiments, one or more media presentations can comprise navigational guidance for a shopper so that the shopper can obtain desired items in an efficient manner.

At step 1040, the personalized shopping system identifies at least one media presentation opportunity at which media can be presented to the shopper, with the identification made while the shopper is at the retail location. The media may be presented to the shopper while the shopper is at the retail location and/or the media may be presented to the shopper at a later time based on activity at the retail location. For example, some media presentation opportunities may comprise one or more points at which to provide in-store displays or advertisements to the shopper, while other opportunities comprise points at which information can be e-mailed or otherwise provided to the shopper for off-site consideration.

Media presentation opportunities can be identified using any number or types of information. Three exemplary factors are shown at 1042 (shopper input), 1044 (tracking data), and 1046 (behavior/history analysis).

For instance, shopper input 1042 may represent explicit requests for information from the shopper. As noted above, a shopper may provide one or more requests as part of the shopper's media preference data. However, some or all of this information may be derived from in-store changes to the media preference data from the shopper. For instance, the shopper may provide a visual and/or audio request for information and/or changes to the shopper's media preferences that are received by the personalized shopping system and analyzed. For example, the shopper may point to a product and/or stare at a product, which can be interpreted as input. Further, the shopper may state a request for information about a particular product, or may point to (and/or stare at) a product while making the request. As another example, the shopper may input data using a device, such as at a kiosk or using the shopper's cell phone, PDA, or other equipment while in the store.

Tracking data 1044 can comprise information about the shopper's in-store activities. For instance, while at the retail location, the shopper's particular location therein may be tracked to any suitable level of detail. For instance, the shopper may be tracked via scanning RFID tags, and/or by analyzing visual or audio data correlated to the shopper to determine where and how the shopper is moving about the retail location. Based on the shopper's location and/or proximity to certain items or areas of the location, one or more media presentation opportunities may be identified. Tracking data 1044 may also comprise information about other items carried on, by, or with the shopper. For example, based on identifying items in the shopper's grocery cart, advertisements for complimentary items may be presented to the shopper when the shopper approaches the area of the store at which those items are displayed.

Behavioral and history analysis data 1046 represents the end result of analysis of shopper data over a period of time. As was noted above, some analysis of shopper in-store activity and input can be used to identify one or more media presentation opportunities. Additionally or alternatively, more sophisticated analysis of the shopper's in-store and past activities may be employed in order to identify opportunities to provide highly-targeted information to the shopper. For instance, some targeted advertising systems have been proposed wherein information such as demographic data purchase histories can be analyzed to develop a shopper profile which is then used to target advertising. As an example, artificial intelligence, neural networks, and/or expert systems can be used in order to analyze such information. Such shopper profiles can be employed by a personalized shopping system of the present subject matter to identify potential media presentation opportunities. Additionally, the shopper's media preferences and current in-store activity can also be taken into account to attempt to identify points at which advertisements and other information can be presented to the shopper, and which types of advertisements/information are likely to be most relevant to the shopper.

The number and timing of media presentation opportunities can vary in different embodiments, and will depend on the particular types of available media presentation equipment, the particular I/O devices which can be used to obtain data about shoppers, and the particular layout, purpose, and other aspects of a retail location. Thus, the list of potential media presentation opportunities presented by way of example below is not intended to be exhaustive:
background audio (e.g. music with or without advertisements)
advertisements via in-store video monitors/projections
advertisements point-of purchase displays (still, video, or audiovisual)
directed audio advertisements
advertisements comprising printed matter (e.g. coupons, flyers)
non-printed coupons (e.g. e-mailed coupon to PDA or other device)
non-directed audio advertisement at a display
advertisement or information transmitted to shopper computing device for review by the shopper at the retail location and/or after the shopper has left the retail location

Additionally, the identification of media presentation opportunities can be an ongoing process that occurs during some or all of the time the shopper is at a retail location.

In some embodiments, the personalized shopping system further takes into account shopper preferences with regard to the use of the shopper's private information. For example, if the personalized shopping system is interfaced to a loyalty program or profiling system, media presentation opportunities can be identified based on detailed information about the shopper. However, the shopper may specify privacy preferences which indicate the type(s) of acceptable information which can be used, and/or the extent to which information about the shopper can be revealed (if at all) when providing targeted advertisements or other information. The privacy parameters may be included as part of the media preference data or may be considered separately when identifying media presentation opportunities and/or presenting media to the shopper.

At step 1050, for each opportunity the personalized shopping system determines whether the shopper desires to receive the media presentation. This may be based at least in part on the shopper's media preference data, and may be a significant improvement over other targeted advertising systems. For instance, the personalized shopping system may be able to identify hundreds or thousands of opportunities at which advertisements or other information could be presented to the shopper. However, by referencing the shopper's preferences, the personalized shopping system can avoid annoying the shopper, which can result in a more desirable shopping experience. Further, when the shopper does not receive all possible advertisements or other information, the advertisement/information which are received may be viewed more favorably. This may result in additional value for retailers, advertisers, and other non-shopper users of the personalized shopping system, as well as the shoppers themselves.

Evaluating can be achieved in any suitable manner. The particular steps taken to analyze the shopper's preferences will depend on factors such as the type and format of the shopper's preference data and the underlying information about the media presentation opportunities. In some embodiments, artificial intelligence, neural networks, and/or expert systems can be employed in order to analyze the shopper's preferences with regard to each particular identified presentation opportunity. In some instances, the analysis may be relatively straightforward, such as when a shopper specifies “no advertisements whatsoever.” Another relatively straightforward instance could include one in which a shopper specifies “no advertisements except as part of a response to a request from me.” In other cases, the analysis may be more nuanced, such as when a shopper's preferences indicate particular desired types, content, and conditions for presenting advertisements in a store.

As shown at step 1055, if analysis of the preference data indicates the shopper does want to receive the presentation(s) associated with a particular opportunity, then the personalized shopping system sends one or more signals to present media to the shopper in accordance with the shopper's preferences. The particular signal(s) will depend on the device or devices used to provide the media. For instance, the personalized shopping system can send audio, visual, or other data to appropriate components or sub-systems which handle presenting the media to the shopper. If a shopper's computing device, such as a cell phone, PDA, music player, or other computing device is used to provide the media presentation, appropriate signals can be sent to such device(s) over a suitable network connection.

If the analysis indicates that the shopper does not wish to receive media at a particular opportunity, then the personalized shopping system moves to step 1060 and onto analyzing the next opportunity (if any). If no further opportunities are identified, then as shown at step 1080, the personalized shopping system determines if the shopper is still at the retail location. If the shopper is no longer at the location, or at a portion of the location at which personalized shopping is provided, then process 1000 ends as to that shopper. However, if at step 1080 the shopper is still at the location, then the process returns to step 1040.

This loop is intended to indicate the ongoing analysis of potential media presentation opportunities by the system; it will be understood that the system can attempt to identify media presentation opportunities while analyzing whether a shopper wishes to receive a particular media presentation and/or while providing a presentation to a shopper.

As will be appreciated, the underlying hardware which may be used to support a personalized shopping experience can comprise any suitable configuration of media presentation devices, I/O devices, and computer hardware and software. Next, several examples of a personalized shopping experience for different customers shown in FIG. 1 will be discussed.

Customer A

For example, customer A may arrive at retail location 10 and enter store 12, wishing to obtain a product 22. Customer A may have specified a preference not to receive any targeted advertisements while at location 10. For instance, customer A may log onto a web site from his home or another location other than retail location 10 to provide shopping preferences. As another example, customer A may have provided such preferences when signing up for a loyalty program. Accordingly, while at retail location 10, customer A does not receive any targeted advertisements. For instance, customer A may pass RFID scanners 56-1 and 56-2, which recognize customer A from one or more RFID tags on his credit cards. As another example, customer A may be recognized by analysis of visual data from camera 54-1, such as facial recognition, or retinal scanning. Customer A may “flash” one or more forms of identification which are recognized by camera 54-1. As another example, other suitable I/O devices, such as bar code scanners, fingerprint recognition sensors, and/or a computer terminal whereby a customer can “log in” may be positioned at entrance 16 (and/or at other parts of retail location 10) for customer identification and/or tracking.

As customer A moves through store 12, computer system 90 may recognize multiple media presentation opportunities. For instance, one media presentation opportunity may comprise the opportunity to present background audio to customer A. For example, the background audio may comprise music. If customer A provided information regarding preferred background audio, then computer system 90 may direct speakers 60 to provide such audio to customer A as he moves through the store. For example, speakers 60 may provide directed audio to customer A comprising a preferred satellite or other radio station. As another example, audio in this or other embodiments may be provided by transmitting appropriate signals to a customer device. For instance, if customer A carries a portable music player, music may be streamed to the music player, such as via data access point 58.

Customer A eventually reaches display 20 and begins to select a suitable product 22. During this time, camera 54-4 may recognize that customer A is staring at display 20 and/or particular products 22 and may recognize a media presentation opportunity. For example, the opportunity may comprise a point at which an audio advertisement for a variant of product 22 can be presented. For instance, if a customer is staring at one brand of a product 22, the advertisement may provide information about that brand. As another example, the media presentation opportunity can comprise providing information about or a coupon for a competing product.

However, customer A has indicated that he does not to receive any advertisements. Thus, although the system may recognize the opportunity to provide a print or advertisement, no such flyer or advertisement is initially provided for customer A. On the other hand, while other customers are near display 20, coupons, audio, and/or other media presentations may be provided to such customers.

Customer A may change his media preferences while at retail location 10. For instance, customer A may wish to use a coupon for purchase of a particular product 22, but may realize he has left the coupon at home. In this example, the personalized shopping system is configured to offer an incentive, namely a coupon, to interested customers in exchange for receiving one or more in-store advertisements.

Assuming customer A wishes to receive a coupon, he can provide data indicating his change of preferences in any suitable way. For example, customer A may provide a verbal request via one or more microphones 52 which is identified by speech recognition. As another example, customer A may log into a website or other suitable interface to change his preferences using a computing device (not shown), such as a cellular phone, PDA, or the like. As another example, a terminal or other input device may be positioned near display 20 whereby customer A can indicate his preference change.

Once customer A has changed his preferences to allow advertising in accordance with the incentive offer, printer 62 may be directed to provide the coupon. In this example, the coupon is printed. However, in some embodiments, coupons may be provided electronically, such as to a computing device associated with A. For example, an electronic coupon may be e-mailed or otherwise transferred to A's cell phone, PDA, or other computing device. As another example, the personalized shopping system may credit A and/or discount A's purchase once A reaches check-out area 18. In some embodiments, the system e-mails a coupon and signals a point-of-purchase system to credit the customer at purchase, with the e-mailed coupon serving as a back-up in the event the customer cannot successfully redeem the discount at check-out. Additionally or alternatively, A may be provided a physical and/or electronic rain check if A's item of interest is unavailable.

Further, while A remains at retail location 10, advertisements or other information may be targeted to customer A by the personalized shopping system. For example, A's preferred background audio may be interrupted by audio commercials. As another example, when customer A is near other displays, such as display 28, other types of media presentations may occur.

Customers B, C, and D

In this example, customer B is near display 24 selecting one of several variants of product 26. For example, the personalized shopping system may recognize customer B's proximity to display 24 via RFID scanner 56-5 and/or visual or audio analysis. In this example, assume customer B is not unwilling to receive advertisements. Once B is at or near display 24, the personalized shopping system may recognize a media presentation opportunity, such as the opportunity to present an audiovisual advertisement to customer B. Accordingly, the system signals display 64 to provide video to catch B's attention. Although some advertisements may be video-only, in this example, audio for the advertisement is provided via speaker 60-1. If speaker 60-1 comprises a phased array of ultrasonic speakers, the audio may only be heard by B without disturbing nearby customers C and D.

As another example, the audio for the advertisement may be provided for both B and D, since they are both in proximity to display 24. For example, the phased array may be configured to “target” both B and D, or the audio may be provided by one or more “standard” speakers at or near display 24. However, this situation may not please customer C, who is nearby. For example, customer C may be thoughtfully considering which product 34 to select from display 32 and may be irritated by the unrelated audio. If customer C has not provided a preference already, she may indicate to the system that she does not wish to hear nearby advertisements. In this example, customer C provides this information via nearby microphone 52, although other means could be used. In accordance with customer C's preferences, the personalized shopping system sends one or more signals to a suitable noise cancellation device so that, while the media presentation is provided to other shoppers (B and D in this example), audio form the presentation is substantially cancelled out for C. For example speakers 60-2 may comprise a suitable phased array which can cancel out the audio for C. Additionally or alternatively, audio from speaker 60-1 may be directed away from C, if possible.

Customer E

In this example, customer E is also near display 20. For example, E may have a shopping list which he has provided to the personalized shopping system. For instance, his list may be provided on-line via a web or other interface and/or E may have provided a list while at location 10, such as by uploading a list from his cellular phone, PDA, or other computing device. Based on the shopping list and/or other items carried by E, the personalized shopping system may recognize a media presentation opportunity while E is near display 20. For instance, artificial intelligence (AI) routines included in the personalized shopping system may recognize that display 20 comprises one or more items on or complementary to items on E's shopping list. As another example, display 20 may comprise products that can be cross-promoted with items already carried by E (e.g. accessories for items in E's shopping cart). The personalized shopping system may present one or more audio, visual, printed, or other advertisements (or other media presentations) to E while he is near display 20.

As another example, customer E may represent a shopper who has a particular purchase in mind, but cannot find what he desires in the available variants of product 22. For example, E's preferred brand or style of product 22 may not be available at display 20. Customer E may request a suitable substitute for his preferred product 22, such as via voice or other communication with the personalized shopping system. The personalized shopping system may then provide a media presentation comprising E's requested information. The presentation may be in the form of one or more advertisements, or may be presented in a more neutral context. For example, speakers 60-4 may provide audio comprising a synthesized or recorded voice that presents the information (and/or advertisement) to E regarding substitute products.

Customer F

Customer F in this example represents a customer who desires detailed information about one or more particular products. For instance, if clothing products 30 in display 28 represent different types of sporting gear, customer F may wish to review data about products 30 in close detail to determine if the products meet her needs. In some embodiments, customer F can request such information from the personalized shopping system. For example, customer F may look at one or more particular products 30 and say “email brochure.” Camera 54-2 may determine which product(s) customer F was looking at when the request was made, while identifying the audio via microphones 52 to determine that a media presentation opportunity exists, namely the opportunity to provide F's desired information. Then, the personalized shopping system may email one or more product brochures (or other information) to customer F.

As another example, customer F may make the request via her cellular telephone 70, which may also receive the brochures or other requested data. For instance, if her cellular telephone 70 includes Bluetooth or Wi-Fi and access point 58 supports such communication, the brochures or other data may be provided directly.

As was noted above, a personalized shopping system can identify one or more media presentation opportunities, but may be configured to evaluate, for each opportunity, whether the shopper desires to receive the media associated with the opportunity. In some embodiments, the system is configured to offer shoppers the opportunity to change their preferences in exchange for one or more incentives. The incentives can include, but are not limited to, coupons, discounts, payments, and any other transfer of value to the shopper.

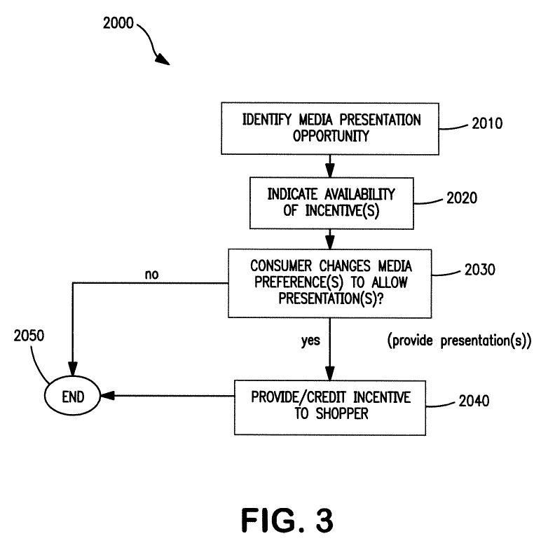

FIG. 3 shows steps in an exemplary process 2000 for offering an incentive to a shopper. For example, as shown at 2010, the personalized shopping system may identify a media presentation opportunity while the shopper is at a retail location. However, the shopper's current media preference data indicates the shopper does not wish to receive the media presentation. The shopper may wish to receive no media at all, or his or her preferences may exclude certain types of presentations for which an incentive is available. At 2020, the personalized shopping system indicates that an incentive is available and accompanying conditions. For instance, if the shopper's media preferences allow, a brief message may be displayed to the shopper or provided to the shopper in audio form. As another example, a text or other message may be provided to the shopper. At 2030, the system determines if the shopper's preference data indicates the requisite change to allow the presentation. If so, then at 2040, the incentive(s) are credited to the shopper. The incentive may be in any form, including, but not limited to, a physical coupon, an electronic coupon transmitted to the shopper's PDA, cell phone, or other device, a discount credited to the shopper at check-out, a transfer of funds to the shopper, or a voucher, coupon, or other indicator of value e-mailed to the shopper. The incentive may be contingent upon the shopper actually receiving the media presentation, which is provided once the shopper's preferences change. At 2050, this sub-process ends. Step 2050 is reached immediately if the shopper does not change his preferences.

In the example above, the incentive was offered while the shopper was at a retail location. However, in some embodiments, the incentive(s) can be offered to the shopper while the shopper is elsewhere, such as when the shopper is configuring media preferences from home (or another location). For example, the web site or other interface whereby the shopper provides his or her media preferences may indicate available incentives for different types or levels of targeted advertising to influence the shopper's selections.

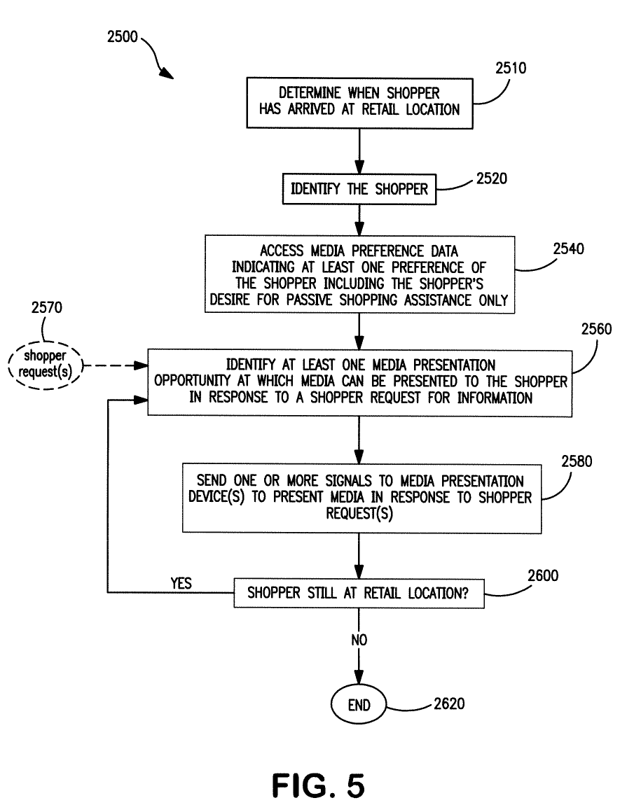

Turning now to FIG. 5, another exemplary process 2500 is shown for providing relevant information delivery in a personalized shopping experience. In this example, the personalized shopping system operates in a passive response mode. That is, the system does not provide information to shoppers unless or until information is requested. The provided information can include advertisements or promotions in some cases.

At steps 2510 and 2520, the system determines when the shopper has arrived at a retail location and identifies the shopper, respectively, as noted above. At step 2540, the system accesses media preference data indicating at least one preference of the shopper, including a preference of the shopper for passive shopping assistance only. If a personalized shopping system is configured only to provide passive assistance to all customers, step 2540 would not be needed.

At step 2560, the system identifies at least one media presentation opportunity at which media can be presented to the shopper in response to a request by the shopper for information. For instance, step 2560 can represent the system standing by for a request from the shopper. In some embodiments, opportunities are identified, but no further action is taken unless or until the shopper makes a request. However, in some embodiments, the system does not attempt to identify any media presentation opportunities at all until a request is received from the shopper.

A shopper request is shown at 2570 as an input. This request can comprise one or more interactions by the shopper. For example, the shopper may make a verbal request for information which is received via in-store microphones and analyzed using voice recognition as noted above. Shopper input may additionally or alternatively comprise gestures or movement (e.g. pointing to, staring at, a product). Other types of input, such as an electronic request made via a cell phone, PDA, or other computing device, may be used as well.

In any event, at 2580, the personalized shopping system sends one or more signals to appropriate devices to present media in response to the shopper request in any suitable manner. For instance, the devices can include one or more media presentation devices such as speakers, video displays, and the like in the store. The media may be presented via one of the consumer's devices as well, such as a brochure or other information e-mailed or otherwise transmitted to the shopper's PDA, cell phone, or other device.

The media presentation can comprise information responsive to the shopper's request. This may or may not include an advertisement or promotion, and may depend in part on other preferences of the shopper. For example, in some embodiments, the shopper may request the location of certain items in the store, such as peanut butter. The personalized shopping system may recognize the request and direct the shopper to the peanut butter aisle while also presenting an advertisement for one or more particular brands of peanut butter and/or alerting the shopper of a sale or other promotion.

At 2600, the system determines whether the shopper remains at the retail location and, if not, the process ends at 2620. If the shopper remains, the process loops back to 2560 to await additional shopper input.

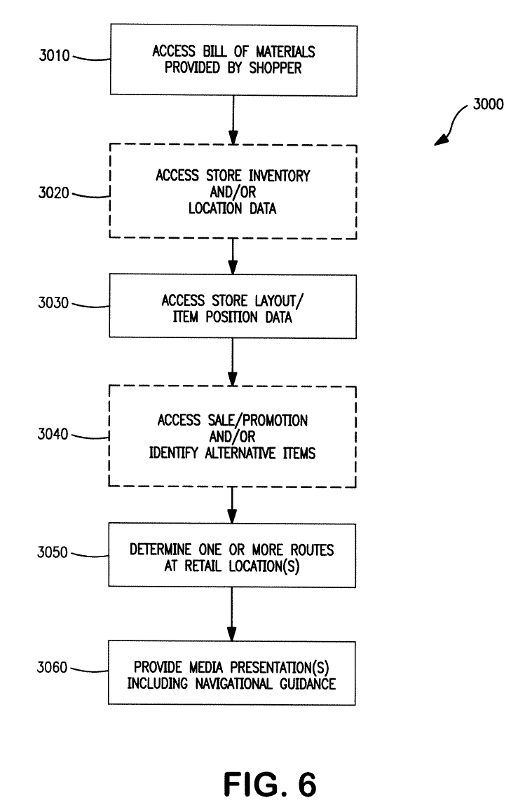

FIG. 6 depicts an exemplary process 3000 whereby a particular media presentation regarding in-store navigation is provided to a shopper. At step 3010, the personalized shopping system accesses a bill of materials based on information provided by a shopper. For instance, the shopper may log into a store web site and specify a list of items (e.g. a shopping list, project checklist etc.). As another example, the shopper may maintain a list of items on a cell phone, PDA, or other computing device that interfaces with the personalized shopping system before and/or while the consumer is at a retail location.

Step 3020 represents an optional step wherein the personalized shopping system evaluates the bill of materials against store inventory data and/or location data. For example, if personalized shopping system supports multiple retail locations, some locations may have items in-stock, while other locations may be out-of-stock as to certain items. The stock status of the shopper's desired items can be used to recommend one or more particular locations for the shopper to visit. Additionally or alternatively, the shopper may be given the opportunity to back-order one or more unavailable items, or to put available items on hold pending the shopper's actual arrival at the retail location. If a personalized shopping system is implemented to support multiple retailers, the system could determine a plurality of retail locations for the shopper to obtain desired items and direct the shopper to such locations.

At step 3030, the personalized shopping system access store layout data. For instance, a retailer may maintain data regarding the layout of its store(s) for use by personnel in stocking and otherwise managing retail locations. This layout data is often referred to as a “Plan-A-Gram” or “Plan-O-Gram.” This information can be maintained in a computer-readable form and at variable levels of detail (e.g. departments, product categories, or by specific items). By cross-referencing the shopper's desired bill of materials to the plan-a-gram and/or other data indicating the position of items at one or more retail locations, the personalized shopping system can develop navigational data that can be used to aid the shopper while at the one or more retail locations. This is shown at 3050 which can comprise determining one or more paths or routes through one or more retail locations. Any suitable pathfinding algorithm(s) can be used to develop the route(s), with the selection of an optimal route being a function of factors such as the desired items, shopper preferences, store layout, shopper characteristics, and other factors. The navigational data can be used as the basis for one or more media presentations provided to the shopper as indicated at 3060.

In some embodiments, optional step 3040 is included, wherein the system accesses sale or promotional data for use in cross-promoting items and/or suggesting alternative purchases to maximize the shopper's savings. Additionally or alternatively, the system can identify substitute items in case the shopper's desired item(s) are not in stock.

The media presentation(s) can take any suitable form. For example, the personalized shopping system may develop a map for routing a shopper through a store. The map may be printed for the shopper at the retail location and/or may be emailed or otherwise provided to a shopper computing device (e.g. emailed to the shopper's PDA). A “map” kiosk where shoppers check in and/or provide a list of desired items may be especially advantageous from the point of view of shoppers who are not computer-savvy. In any event, while at the store, the shopper could be prompted, if desired, with directions to the next item(s) on the shopper's bill of materials. For instance, the prompts could be provided by one or more speakers in the store, either using broadband audio or the directional audio discussed above. Non-audio prompts could be provided in some embodiments.

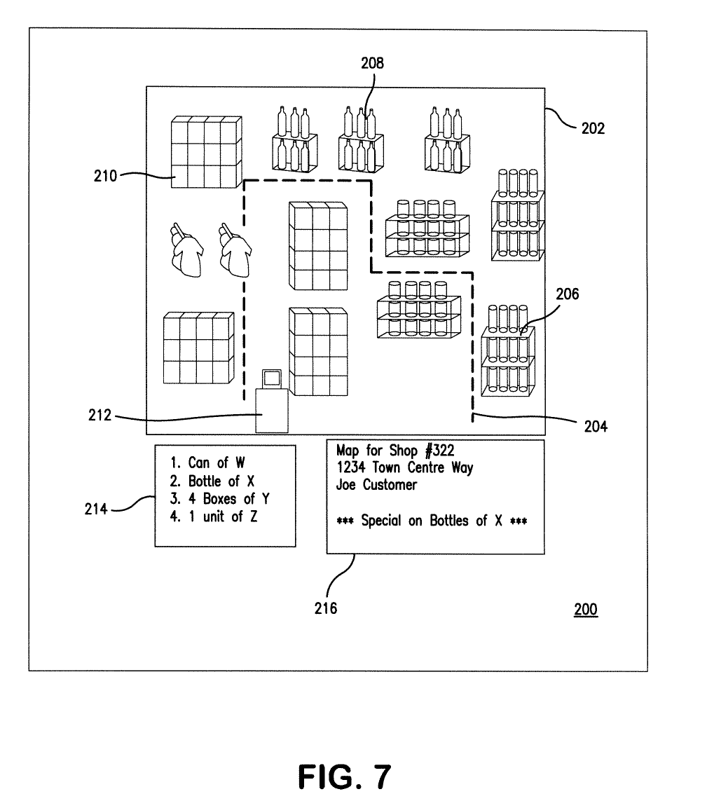

FIG. 7 is an example media presentation 200 including navigational guidance, in this example a map 202 of a store showing a route 204 from an entry point at the store past a plurality of product displays 206, 208, 210, and on to check out area 212. In this example, the media presentation 200 further includes a reproduction of desired items shown in list form at 214, along with an additional area 216 indicating the retail location's address, shopper's name, and a promotional message. Route 204 may, for instance, be selected to move through the store in the most efficient manner for a shopper to obtain his desired items as indicated on the list, which may be found at displays 206, 208, 210, and the like. As was noted above, media presentation 200 may be printed for the shopper at home or at a retail location and/or may be sent to a computing device, such as a PDA, cell phone, or the like, associated with the shopper.

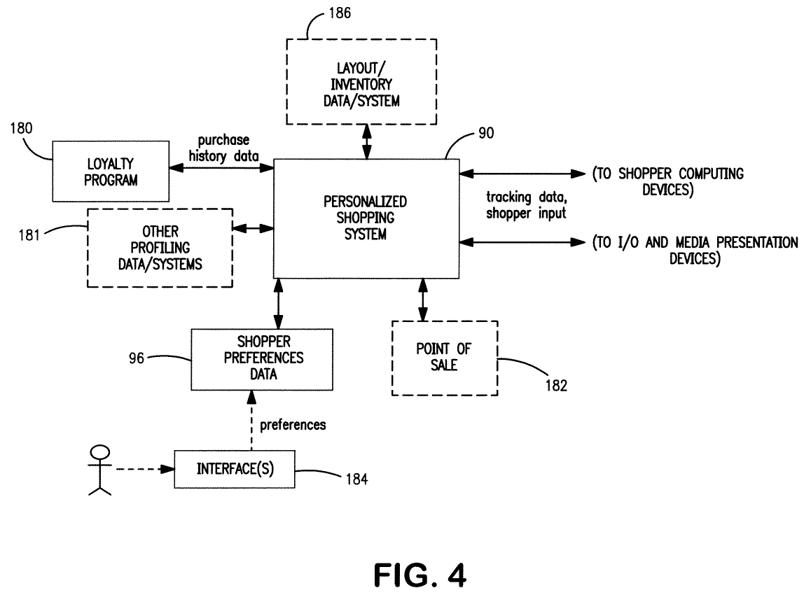

Briefly, FIG. 4 is a block diagram showing interconnections between a personalized shopping system 90 and various other components. In this example, the system is interfaced to data store 96, which includes shopper media preference data. An exemplary shopper is shown to provide such data via interface 184. Interface 184 can comprise any number or type of computer interfaces which allow the shopper to provide his preferences, such as a web site, a kiosk at a retail location or elsewhere, or an automated voice response system. As was noted above, the shopper may provide specific rules or generalized preference information which is analyzed to determine rules for use by the personalized shopping system. Such analysis may occur when the shopper provides his or her preferences and/or may occur as part of determining whether a shopper's preferences allow or disallow a particular media presentation.

In this example, connections are shown between system 90 and computing devices associated with a shopper, such as shopper personal computers (PCs), mobile computers, personal digital assistants (PDAs), cellular telephones, media players, and the like. Such connections may be used to provide media presentations and to send and receive other data from such devices. In some embodiments, shopper information, such as purchase histories, personal information, and media preferences can be obtained from such devices, subject to the shopper's preferences with regard to releasing such information. In some embodiments, a computing device associated with the shopper may comprise a suitable device loaned or rented to the shopper while at a retail location, such as a cart-mounted or portable terminal.

Connections are shown to various presentation devices, such as the speakers, video displays, and wireless data transfer equipment noted above. Additionally, FIG. 4 shows a connection over which data including shopper tracking data and shopper input is received from in-store I/O devices.

System 90 is further shown to be connected to a loyalty program system 180 which can provide information including shopper purchase history data. Another system 181 is shown as a source of other profiling data, such as shopper demographic and other information which may be available. Personal shopping system 90 is further shown to be interfaced to point of sale system 182, which can allow for crediting of incentives to appropriate shoppers in embodiments in which advertisements are presented in exchange for providing incentives to shoppers.

It will be noted that, in some embodiments, system 90 is connected to multiple instances of loyalty programs, information sources, and the like. For instance, the system may be capable of analyzing purchase history data from several different retail entities in order to obtain a complete picture of a shopper.

In some embodiments, the shopper tracking inputs can further be used to expedite the check-out process, such as by identifying items selected by the shopper (e.g. via scanning product RFID tags or chips), obtaining payment information/authorization form the shopper (e.g. by confirming total and payment via voice, visual display, fingerprint, etc.), and allowing the shopper to leave after successful payment.

Additionally, personalized shopping system 90 in this embodiment is shown as optionally connected to store layout / inventory data system 186. System 186 maintains data regarding the position of items in one or more retail locations, and in this example further includes inventory data, such as stock levels. In other embodiments, store layout data and inventory data may be maintained separately. Such information can be used to determine one or more routes through a retail location (or locations) as a basis for providing navigational guidance to shoppers.

In some embodiments, the personalized shopping system is itself a component in one or more other systems which provide additional functionality at the retail location. Thus, the depiction of personalized shopping system 90 in FIG. 4 is for purposes of illustration only.

The examples above discussed retail locations at which products, such as grocery and personal care products, are displayed and provided to shoppers. Other such stores could include, but are not limited to: furniture stores, electronics stores, office supply stores, clothing stores, pet stores, and any other conceivable retail establishment.

Further, in several of the examples, the media presentations comprise advertisements. However, the present subject matter is applicable to other contexts at which services are provided at the retail location and/or the media presentation(s) do not comprise advertisements. Other media presentations could comprise product information brochures, product instructions, safety information, product data sheets, and the like. For instance, shoppers may desire product information regarding ingredients/source materials, whether or how products can be recycled, other product disposal information, and maintenance information.

As an example of another context, in a pharmacy retail location, a shopper could use a PDA or other device to provide media preference data indicating a requested drug prescription and a request for related information. The media presentation opportunity could comprise providing drug and other information (e.g. drug interaction warnings, directions for use, etc.) to the shopper. The information could be based on tracking data, such as information about the other items or drugs the shopper is carrying or taking. For example, if certain foods are incompatible with the shopper's prescription or over-the-counter drugs, the personalized shopping system could alert the shopper if he/she has selected items comprising the incompatible foods, or has such items on a shopping list. The personalized shopping system could suggest alternative food items and/or substitute drugs, as appropriate, and could cross-reference previous purchase data. For example, if a shopper is purchasing an over-the-counter medicine containing acetaminophen and currently (or recently) purchased alcohol, the personalized shopping system could alert the shopper to potential dangers of combining the two.

The shopper could indicate in her media preference data that she considers all such information private, and so targeted audio could be provided to the shopper so others would not overhear any audio provided about the drugs. Noise cancellation could also be used to prevent other shoppers from overhearing the media. Of course, the particular technique(s) used to provide the media to the shopper would depend on the shopper's particular preferences. For example, the pharmacy context may be one in which e-mailing or otherwise providing data to a shopper's cell phone, PDA, or other device is particularly appropriate.

As mentioned above, a personalized shopping system may be configured to support one retail location or multiple retail locations. The multiple retail locations may be associated with the same entity, or with multiple entities. In embodiments in which the personalized shopping system is implemented for locations associated with multiple entities, shoppers can specify privacy and/or media preferences on a case-by-case basis. For example, a shopper may allow targeted advertisements based on his prior drug purchase history at a drugstore, but may not allow such advertisements at a grocery store. Taking the concept further, the personalized shopping system may have access to detailed information about the shopper, such as medical history information. Accordingly, the shopper may allow the system to use such information while making recommendations while at a drug store or doctor's office, but not to make product recommendations at a discount retailer.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

When data is obtained or accessed between a first and second computer system or component thereof, the actual data may travel between the systems directly or indirectly. For example, if a first computer accesses a file or data from a second computer, the access may involve one or more intermediary computers, proxies, and the like. The actual file or data may move between the computers, or one computer may provide a pointer or metafile that the other computer uses to access the actual data from a still further computer.

The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality complementary or unrelated to the present subject matter, as well. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, some embodiments of the methods and systems set forth herein may also be implemented by hard-wired logic or other circuitry, including, but not limited to application-specific circuits. Of course, combinations of computer-executed software and hard-wired logic or other circuitry may be suitable, as well.

Embodiments of the methods disclosed herein may be executed by one or more suitable computing devices. For instance, a personalized shopping system may comprise one or more sub-systems that can provide the functionality noted above. Such system(s) may comprise one or more computing devices adapted to perform one or more embodiments of the methods disclosed herein. As noted above, such devices may access one or more computer-readable media that embody computer-readable instructions which, when executed by at least one computer, cause the at least one computer to implement one or more embodiments of the methods of the present subject matter. Additionally or alternatively, the computing device(s) may comprise circuitry that renders the device(s) operative to implement one or more of the methods of the present subject matter. Furthermore, components of the presently-disclosed technology, such as databases used to store purchase history data, shopper demographic data, shopper media preferences, the underlying data for media presentations, and other data may be implemented using one or more computer-readable media.

Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other memory devices, and the like. The present disclosure also makes reference to the relay of communicated data over one or more communications networks. It should be appreciated that network communications can comprise sending and/or receiving information over one or more networks of various forms. For example, a network can comprise a dial-in network, a local area network (LAN), wide area network (WAN), public switched telephone network (PSTN), the Internet, intranet or other type(s) of networks. A network may comprise any number and/or combination of hard-wired, wireless, or other communication links.

The terms “comprising” and “including” are used interchangeably herein in a non-limiting sense. Furthermore, unless explicitly stated otherwise, the use of the phrase “based on” is also meant to be non-limiting and have the same definition as “based at least on.” For example, description of a calculation “based on” factors A, B, and C is not meant to exclude a calculation that utilizes A, B, C, and one or more other factors D.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

1. A system for providing a personalized shopping experience, the system comprising at least one computing device and at least one media presentation device in communication with the at least one computing device, the at least one computing device configured to:
determine when a shopper has arrived at a retail location and identify the shopper;
access media preference data indicating at least one preference of the shopper regarding in-store media;
while the shopper is at the retail location, identify at least one media presentation opportunity at which media can be presented to the shopper;
for each media presentation opportunity, determine, based at least in part on the media preference data, whether the shopper desires to receive the media presentation; and
send a signal to at least one media presentation device to present a media presentation to the shopper in accordance with the shopper's at least one preference regarding in-store media.

2. The system set forth in claim 1, wherein the at least one computing device is further configured to:
receive data identifying a change in the media preference data provided by the shopper while the shopper is at the retail location.

3. The system set forth in claim 2, wherein the system further comprises at least one microphone in communication with the at least one computing device, and the data identifying at least one change in the media preference data is derived from an audio request made by the shopper via the microphone.

4. The system set forth in claim 2, wherein the at least one computing device is configured to receive data identifying a change in the media preference data from a computing device associated with the shopper.

5. The system set forth in claim 2, wherein at least one media preference parameter comprises a request for information from the shopper, and the at least one computing device is further configured to:
select a set of data based on the request for information; and
provide the selected data to the shopper.

6. The system set forth in claim 5, wherein:
the set of data comprises a media presentation; and
providing the selected set of data comprises sending a signal to at least one media presentation device to present the media presentation to the shopper.

7. The system set forth in claim 5, wherein:
providing the selected set of data comprises sending the data to a computing device associated with the shopper.

8. The system set forth in claim 1, wherein:
the system comprises s a noise-cancellation device at the retail location; media preference data of a second shopper indicates that the second shopper does not wish to hear advertisements while at the retail location; and
the at least one computing device is further configured to:
send a signal to the noise cancellation device so that, when a media presentation is presented to another shopper, audio from the media presentation is substantially cancelled out for the second shopper.

9. The system set forth in claim 1, wherein the at least one computing device is configured to:
offer an incentive to the shopper in exchange for the shopper selecting a particular preference regarding in-store media.

10. The system set forth in claim 9, wherein the particular preference indicates a willingness to receive an advertisement.

11. The system set forth in claim 1, wherein at least one media presentation comprises an audio message.

12. The system set forth in claim 9, wherein at least one media presentation device comprises a directional audio system.

13. The system set forth in claim 1, wherein sending a signal to at least one media presentation device at least one media presentation device comprises:
sending data comprising the media presentation to a computing device associated with the shopper via one or more wireless access points configured to interface with the computing device associated with the shopper

14. The system set forth in claim 1, wherein at least one media presentation device comprises a printer, and at least one media presentation comprises printed material.

15. The system set forth in claim 14, wherein the printed material comprises a coupon.

16. The system set forth in claim 14, wherein the printed material comprises a map indicating an in-store shopping route.

17. The system set forth in claim 1, wherein at least one media presentation opportunity comprises an opportunity to present an advertisement.

18. The system set forth in claim 1, wherein at least one media presentation opportunity comprises an opportunity to present background audio.

19. The system set forth in claim 1, wherein the at least one computing device is further configured to provide an interface whereby a shopper can specify at least one media preference.

20. The system set forth in claim 19, wherein the interface comprises a web site.

21. The system set forth in claim 1, wherein the at least one computing device is further configured to interface with a computing device associated with the shopper and derive at least some media preference data from data stored on the computing device associated with the shopper.

22. The system set forth in claim 1, wherein the at least one computing device is further configured to access purchase data indicating at least one previous or impending purchase of the shopper; and
wherein at least one media presentation opportunity is identified based at least in part on the purchase history data.

23. The system set forth in claim 1, wherein identifying at least one media presentation opportunity comprises identifying an opportunity to provide information regarding a pharmaceutical product.

24. The system set forth in claim 23, wherein at least one media presentation comprises information about drug interactions or contraindications.

25. The system set forth in claim 23, wherein identifying at least one media presentation opportunity is based at least in part on:
accessing purchase data indicating at least one previous or impending purchase of the shopper and;
accessing data regarding drug interactions or contraindications with regard to at least one previous or impending purchase of the shopper.

26. The system set forth in claim 23, wherein sending a signal to at least one media presentation device comprises:
interfacing with a computing device associated with the shopper and send data comprising the media presentation to the computing device associated with the shopper.

27. The system set forth in claim 26, wherein the at least one computing device is further configured to receive data confirming that the shopper has received the media presentation.

28. A system for providing a personalized shopping experience, the system comprising at least one computing device and at least one media presentation device in communication with the at least one computing device, the at least one computing device configured to:
determine when a shopper has reached a retail location and identify the shopper; and
evaluate shopper preference data indicating whether the shopper desires for a personalized shopping system to respond in an active or passive form; and
while the shopper preference data indicates the shopper desires for the personalized shopping system to respond in a passive form:
provide at least one media presentation to the shopper only in response to an inquiry provided by the shopper.

29. The system set forth in claim 28, wherein the computing device is further configured to:
while the shopper preference data indicates the shopper desires for the personalized shopping system to respond in an active form:
provide at least one media presentation to the shopper based at least on the shopper's location within the retail location.

30. A system for providing a personalized shopping experience, the system comprising at least one computing device and at least one media presentation device in communication with the at least one computing device, the at least one computing device configured to:
access data identifying one or more items desired by a shopper;
determine the position of at least one identified item at one or more retail locations;
determine a route through one or more retail locations so that a shopper following the route will be in proximity to the identified position; and
based on the determined route, provide a media presentation comprising navigational guidance to a shopper.

31. The system set forth in claim 30, wherein the media presentation comprising navigational guidance includes a map of the retail location and a determined route.

32. The system set forth in claim 31, wherein providing a media presentation includes sending data comprising the map to a printer at a retail location.

33. The system set forth in claim 31, wherein providing a media presentation includes sending data comprising the map to a computing device associated with the shopper.

34. The system set forth in claim 30, wherein the at least one computing device is further configured to:
access data indicating the shopper's position within a retail location; and
determine a direction for the shopper to move based on a determined route;
wherein providing a media presentation comprising navigational guidance includes sending data to at least one speaker at the retail location, the data comprising an audio message to a shopper indicating the direction for the shopper to move.

35. The system set forth in claim 30, wherein the at least one computing device is further configured to determine an inventory status of at least one identified item at a plurality of retail locations and select a retail location for visitation by the shopper based on the determined inventory status.
